(19) United States
(12) Patent Application Publication
(10) Pub. No.: US 2007/0039230 A1
(43) Pub. Date: Feb. 22, 2007

(54) Clamp-on rod holder

(75) Inventor: Michael Burnley, Burradoo (AU)

Correspondence Address: ROBERT M. SCHWARTZ, P.A., P.O. BOX 221470, HOLLYWOOD, FL, 33022, US

(73) Assignee: Taco Metals, Inc.

(21) Appl. No.: 11/488,277

(22) Filed: Jul. 18, 2006

Related U.S. Application Data
(60) Provisional application No. 60/700,260, filed on Jul. 18, 2005.

(51) Int. Cl. A01K 97/10

(52) U.S. Cl. 43/21.2

(57) ABSTRACT

A clamp-on fishing rod holder assembly includes a clamp for mounting the assembly. A holster is pivotably attached to the clamp. A rod holder tube is mounted in the holster.

### CROSS-REFERENCE TO RELATED APPLICATIONS

This application claims the benefit of U.S. Provisional Application Ser. No. 60/700,260, filed on Jul. 18, 2005, entitled Clamp-On Rod Holder; and the benefit of U.S. Design Patent Application Ser. No. 29/253,057 filed on Mar. 2, 2006, entitled Clamp-On Rod Holder; the prior applications are herewith incorporated by reference in their entirety.

### BACKGROUND OF THE INVENTION

1. Field of the Invention

The present invention pertains to a fishing rod holder that is used to hold fishing rods on a boat/marine vessel, by mounting to a structure of the boat. Rod holders are typically mounted on T-tops, bow rails, or canopy structures of a boat. More specifically, to a clamp-on fishing rod holder that is mounted to a structure of a boat such as a T-top, bow rail tube, or square tube railings on pontoons.

2. Description of the Related Art

Rod holders typically have a tube for holding a rod and a mounting clamp to attach the rod holder to the boat, for example square tubing found on pontoon boats, T-tops, and leaning posts of a boat. Rod holders can be made of anodized aluminum, stainless steel or other metal material that is resistant to corrosion. Rod holders can also be made of plastic material.

The disadvantages of a rod holder as described above are that the tube that holds the rod is not removable and therefore the tube cannot be changed out to accommodate different sizes of rods. When made entirely of plastic they offer cost savings in manufacture, however, this leads to a rod holder that is less durable. When made entirely of metal, the rod holder offers better durability at an increased cost of manufacture.

### SUMMARY OF THE INVENTION

It is accordingly an object of the invention to provide a clamp-on rod holder which overcomes the above-mentioned disadvantages of the heretofore-known devices of this general type and which provides a rod holder that is more versatile, more economical to produce and easier to use.

With the foregoing and other objects in view there is provided, a clamp-on fishing rod holder assembly, which includes a clamp for mounting the assembly. A holster pivotably attaches to the clamp. A rod holder tube is mounted in the holster.

In accordance with another feature of the invention, the holster includes a hook-shaped lip for engaging a bottom edge of the tube.

In accordance with an additional feature of the invention, the holster and the clamp each have a respective toothed element. The toothed elements oppose each other and engage each other for establishing the orientation of the holster with respect to the clamp.

In accordance with yet an additional feature of the invention, the toothed elements each have respective studs formed thereon for positioning the toothed elements on the holster or the clamp respectively.

In accordance with a further feature of the invention, the clamp is constructed as two halves held together by screw fasteners.

In accordance with yet another feature of the invention, the tube is formed of metal and the holster is formed of plastic.

In accordance with still yet another feature of the invention, the holster has a solid bottom and said solid bottom includes a rod stop.

Other features which are considered as characteristic for the invention are set forth in the appended claims.

Although the invention is illustrated and described herein as embodied as a clamp-on rod holder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a top plan view of the rod holder according to the invention;

FIG. 2 is a side elevational view of the rod holder according to the invention;

FIG. 3 is a front elevational view of the rod holder according to the invention;

FIG. 4 is a sectional view along line A-A of FIG. 3 of the rod holder according to the invention;

FIG. 5 is an enlarged partial sectional view of detail “D” of FIG. 4 of the rod holder according to the invention;

FIG. 6 is an enlarged partial sectional view of detail “E” of FIG. 4 of the rod holder according to the invention;

FIG. 7 is an enlarged partial sectional view of detail “F” of FIG. 4 of the rod holder according to the invention; and

FIG. 8 is an enlarged perspective view of the gear faces of the rod holder according to the invention.

### DESCRIPTION OF THE PREFERRED EMBODIMENTS

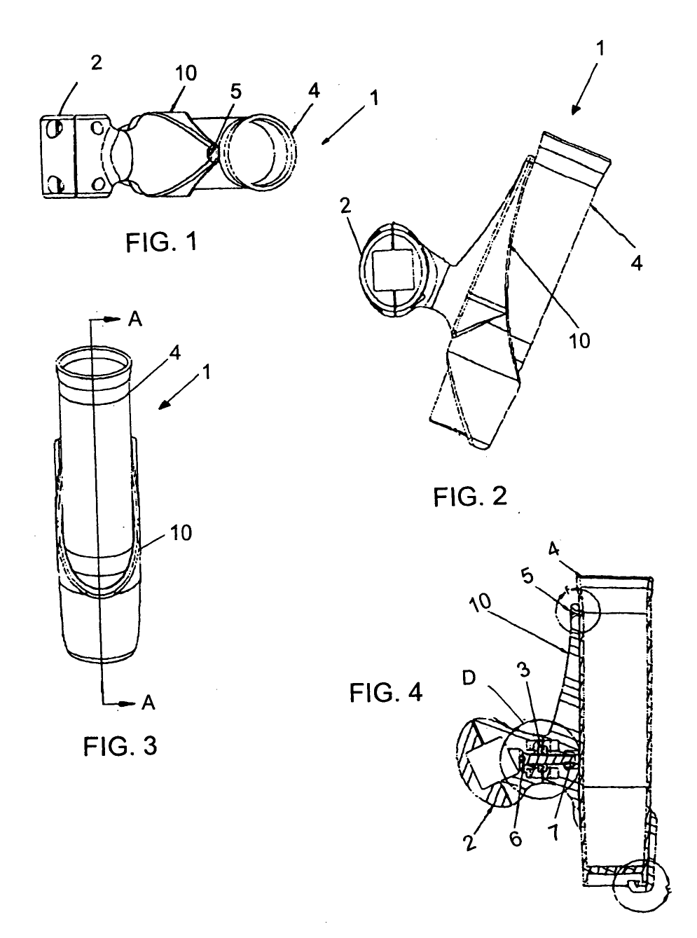

Referring now to the figures of the drawing in detail and first, particularly, to FIGS. 1-4 which illustrate the clamp-on rod holder 1. The rod holder 1 includes a rod holder tube 4 that slides into a bucket or holster 10. The tube 4 is held in place in the holster 10 with a small screw 5. Adhesive may be used in addition to the screw 5. The screw 5 is threaded into the tube 4 via a countersunk hole in the top of the bucket 10 (FIG. 7). The tube 4 is also held in place with a hook-shaped lip 16 that interacts with the bottom end of the tube 4. The tube is made of corrosion resistant metal such as anodized aluminum and the holster 10 is made of plastic such as glass filled nylon (GFN). This construction of the tube 4 and the holster 10 allows for the easy change of different size tubes 4 for accommodating different size rods.

A clamp 2 is attached to the bucket 10. The clamp 2 attaches the clamp-on rod holder 1 to a structure that is part of the boat, such as a bow rail, T-top, or leaning seat post. The clamp 2 shown in FIGS. 2 and 4 is shown for mounting to a square tube, however it is possible that the clamp 2 be constructed to accommodate a round tube. The clamp 2 includes two halves, which are held together by screws. The clamp 2 can be configured for a round tube of whatever size is required. As shown in FIGS. 2 and 4, the clamp 2 is attached to the holster 10 at a substantially right angle, however, this angle can be configured to be any desired angle as required by the construction of the structure on the boat.

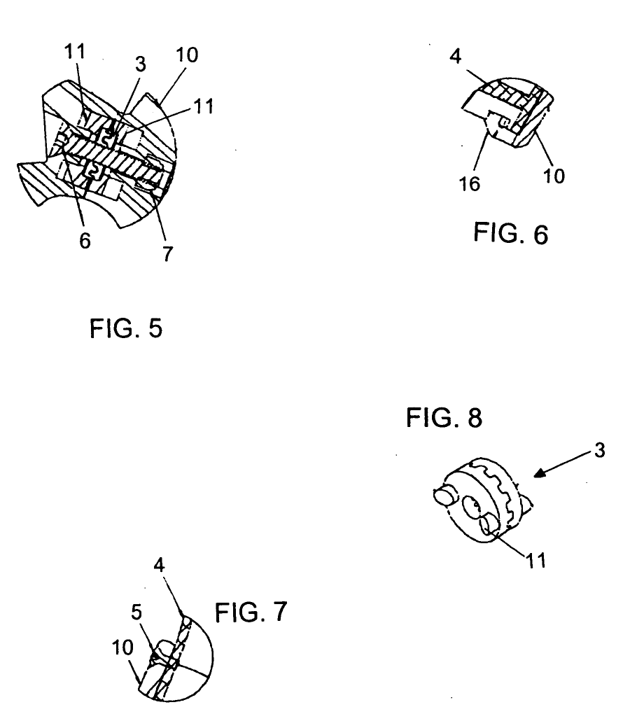

The clamp 2 and the holster 10 are located with respect to each other and are attached to each other via two opposing geared elements or toothed elements 3, which are disposed opposite each other. The toothed elements 3 each have respective legs or studs 11 disposed on the backside of thereof. The legs peg the toothed elements 3 in the clamp 2 and to the holster 10 as required. The legs 11 are pegged into appropriate holes formed in the holster 10 and the clamp 2. A screw 6 and a nut 7 attach the holster 10 and the clamp 2 to one another such that the toothed elements 3 engage one another. This construction allows an adjustment of the angle of the holster 10 and tube 4 with respect to the clamp 2, such that the disposition between the holster 10 and the tube 4 can be set for trolling or rod storage. Furthermore, when the screw 6 and the nut 7 are tightened, the use of the toothed elements 3 ensures that the holster 10 and the tube 4 will remain in the desired position (FIG. 5). The toothed elements 3 can be made of either glass filled nylon or metal such as aluminum, as required.

Although the holster 10 is shown in a cut-away version or sling-type configuration (not solid configuration or a sling-type configuration), it is possible to supply the holster 10 in a solid configuration, where the bottom of the holster is solid. Also, although not illustrated the tube 4 may include a rod stop for a radial orientation of a rod placed in the rod holder. It is also possible for the tube 4 to have an open bottom and for the rod stop to be provided as a part of the holster 10.

I claim:

1. A clamp-on fishing rod holder assembly comprising:
a clamp for mounting the assembly;
a holster pivotably attached to said clamp; and
a rod holder tube mounted in said holster.

2. The assembly according to claim 1, wherein said holster includes a hook-shaped lip for engaging a bottom edge of said tube.

3. The assembly according to claim 1, wherein said holster and said clamp each have a respective toothed element, said toothed elements opposing each other and engaging each other for establishing the orientation of said holster with respect to said clamp.

4. The assembly according to claim 3, wherein said toothed elements each have respective studs formed thereon for positioning said toothed elements on said holster or said clamp respectively.

5. The assembly according to claim 4, wherein said clamp is constructed as two halves held together by screw fasteners.

6. The assembly according to claim 1, wherein said tube is formed of metal and said holster is formed of plastic.

7. The assembly according to claim 1, wherein said holster has a solid bottom and said solid bottom includes a rod stop.
